(19) United States
(12) Patent Application Publication
(10) Pub. No.: US 2008/0194215 A1
(43) Pub. Date: Aug. 14, 2008

(54) METHOD AND SYSTEM FOR RELIABLY SENDING DATA BASED ON DATA SIZE AND TEMPERATURE MARGIN

(75) Inventor: Angel M. Bolanos, Coral Springs, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/673,918

(22) Filed: Feb. 12, 2007

(51) Int. Cl. H04B 17/00; G01S 1/00; H04L 27/00; H04B 1/00

(52) U.S. Cl. 455/115.1; 340/584; 342/357.12; 375/295; 455/91

(57) ABSTRACT

A mobile device (102) and method (200) is provided for reliably sending data at an increased power level which exceeds a nominal transmitter rating. The method can include determining (220) a data size of the data, determining (230) a data rate of the mobile device, calculating (240) a transmission time from the data size and the data rate, evaluating (250) a temperature margin for the transmitter operating at the increased power level in view of the transmission time using a temperature profile (219) stored in a look-up table (160), and controlling (260) a transmitting of the data at the increased power level in view of the temperature margin for protecting the transmitter from excessive heat build-up

### FIELD OF THE INVENTION

The present invention relates to wireless communication location devices and, more particularly, to transmitting data reliably over long distances using low power.

### BACKGROUND

The use of portable electronic devices and mobile communication devices providing location based information has increased dramatically in recent years. Moreover, emergency communication systems are being upgraded on a regular basis to provide improved features, such as faster response times and better accuracy in location determination. A mobile communication device includes a transmitter to send data, such as location information, to a receiving emergency communication system. The receiving system can identify a location of the mobile device from the data and report the location to emergency dispatch teams. The mobile communication device can include a location unit, such as GPS for identifying a location of the device, and a transmitter for sending the location information.

A mobile communication device can be a radio or a cell phone. A radio, which provides two-way dispatch communication, is generally larger in size than a cell phone. The transmitter in a radio generally includes a power amplifier with a high power rating, whereas a transmitter in a cell phone generally includes a power amplifier with a low power rating. The radio can support larger heat sinks that are more capable of dissipating heat from the power amplifier than a small cell phone. Consequently, a high power transmitter in a radio is capable of sending data over longer distances than a low power transmitter of a cell phone.

Low power devices such as cell phones have a transmitter with limited heat sinking that are usually designed to operate under 1 W of average power. In certain cases, the low power transmitter can be requested to transmit data, such as location data, at a higher power or at a higher transmit rate during an emergency situation. This allows the transmitter to increase the range of the mobile communication device in an emergency situation for sending location information. However, requiring the transmitter to operate above a normal specified rating over prolonged periods can result in an overheating of the power amplifier which results in degraded transmit performance. If the power amplifier is operating at a higher power than it's nominal specification, excess heat will be generated and eventually reduce the efficiency of the transmitter. A need therefore exists for allowing a low power mobile communication device to operate at a higher than normal specification for sending location data, or any other information, in an emergency situation.

### SUMMARY

One embodiment is a method for reliably sending data from a transmitter of a wireless communication device. The method can include determining if the transmitter is sending data at an increased power level, evaluating a transmission time for sending the data, evaluating a temperature margin for the transmitter operating at the increased power level in view of the transmission time, and controlling a transmitting of the data at the increased power level based on the temperature margin to protect the transmitter from excessive heat build-up. In such regard, the transmitter will be protected from excessive heat when it is enabled to operate at a much higher power than its intended design. In one arrangement, a pulse compressed signal can be transmitted at a transmitter peak power to increase a transmit range of the wireless communication device in an emergency. Location specific information can be included in the pulse compressed signal for identifying a location of the wireless communication device

The step of evaluating a temperature margin can include determining a data size of the data, determining a data rate of the wireless communication device, and calculating the transmission time from the data size and the data rate. The step of controlling includes increasing or decreasing a continuous outflow of the data during the transmitting based on the data size. The step of evaluating a temperature margin can also include checking a present temperature of the transmitter, determining a rise time of the transmitter to reach a threshold temperature in view of the present temperature, and comparing the transmission time to the rise time to identify a temperature margin.

The step of determining a rise time can include performing a look-up search in a table that charts a temperature of the transmitter versus time with respect to the data rate. A rise time is a time it can take for the transmitter operating at the increased power level to reach the threshold temperature at the data rate. The table can include a temperature profile of the transmitter at the increased power level for a plurality of data rates and transmission times. The data can be transmitted if the temperature margin is positive which occurs when the transmission time is less than the rise time. Alternatively, the data can be temporarily stored if the temperature margin is negative. The method can then include waiting for an operating temperature of the transmitter to fall to a low temperature at which the temperature margin is positive and results in a rise time that is greater than the transmission time before retransmitting the data.

Another embodiment is a wireless communication device comprising a processor, a transmitter operably coupled to the processor that transmits data, and a memory operably coupled to the processor. The memory stores operating instructions that, when executed by the processor, cause the processor to determine if the transmitter is sending data at an increased power level, determine a data size of the data, determine a data rate of the wireless communication device, calculate a transmission time from the data size and the data rate, evaluate a temperature margin for the transmitter operating at an increased power level in view of the transmission time, and control a transmitting of the data at the increased power level based on the data size in view of the temperature margin for protecting the transmitter from excessive heat build-up due to transmitting at the increased power level.

A temperature sensor is operably coupled to the processor that measures a temperature of the transmitter to allow the processor to control a transmitting of data depending on the data size. The processor can receive temperature readings from the temperature sensor, check a present temperature of the transmitter when ready to transmit the data, determine a rise time of the transmitter to reach a threshold temperature in view of the present temperature, and compare the transmission time to the rise time to produce the temperature margin. A look-up table is included that charts a temperature of the transmitter versus time, wherein the operating instructions cause the processor to perform a look-up search for a rise-time in the table. The table includes a temperature profile of the transmitter at the increased power level for a plurality of data rates and a plurality of transmission times.

A global positioning system (GPS) receiver, can be included that is operably coupled to the processor, can receive GPS signals from a plurality of orbiting satellites. The operating instructions further can cause the processor to determine the location of the wireless communication device based at least in part on the GPS signals, and transmit the location with the data. A display can be included that is operably coupled to processor that identifies when the transmitter is operating at the increased power level in an emergency situation.

Yet another embodiment is a wireless communication device tracking system comprising a processor, a transmitter operably coupled to the processor, a temperature sensor operably coupled to the processor that measures a temperature of the transmitter; a location unit coupled to the processor, and memory operably coupled to the processor and location unit. The memory stores operating instructions that, when executed by the processor, cause the processor to determine a location of a wireless communication device from the location unit; create a short message service (SMS) data that includes the location, determine a file size of the SMS data; determine a data rate of the wireless communication device, calculate a transmission time from the file size and the data rate, evaluate a temperature margin for the transmitter operating at an increased power level in view of the transmission time, and control a transmitting of the data by the transmitter at the increased power level based on the temperature margin for protecting the transmitter from excessive heat build-up due to transmitting at the increased power level.

In one arrangement the transmitter is a pulse compression system that transmits the SMS data as a continuous chirp signal at high power for transmitting the SMS data over a long range. The processor monitors the temperature of the transmitter from the temperature sensor in view of the file size, and decreases transmission when the temperature margin is negative and increases transmission when the temperature margin is positive. A look-up table charts a temperature of the transmitter versus rise time. The processor performs a look-up search for a rise-time in the table that corresponds to a file size and data rate. The processor subtracts the transmission time from the rise time to determine the temperature margin. The processor can transmit the SMS data if the temperature margin is positive, at which the transmission time is less than the rise time, or, temporarily store the SMS data if the temperature margin is negative, and wait for an operating temperature of the transmitter to fall to a low temperature at which the temperature margin is positive and results in a rise time that is greater than the transmission time before retransmitting the SMS data.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a mobile communication system for transmitting pulse compressed signals at an increased power level in accordance with the embodiments of the invention;

FIG. 2 is an time domain plot and frequency domain plot of a pulse compressed signal in accordance with the embodiments of the invention;

FIG. 3 is a block diagram of a mobile communication device for transmitting pulse compressed signals in accordance with the embodiments of the invention;

FIG. 4 is a method for reliably sending data from a transmitter of a wireless communication device at an increased power level in accordance with the embodiments of the invention;

FIG. 5 is a look-up table that identifies a temperature profile of a transmitter in accordance with the embodiments of the invention;

FIG. 6 is an exemplary temperature profile of a transmitter in accordance with the embodiments of the invention;

FIG. 7 is a method for determining a temperature margin in accordance with the embodiments of the invention;

FIG. 8 is a temperature profile identifying a temperature margin in accordance with the embodiments of the invention;

FIG. 9 is a look-up table for various transmission times in accordance with the embodiments of the invention;

FIG. 10 is a method for controlling transmission in accordance with the embodiments of the invention;

FIG. 11 is a flow chart for reliable sending data at an increased power level in accordance with the embodiments of the invention; and

FIG. 12 is a method for reliably sending location data at an increased power level in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as number of suitable processors, controllers, units, or the like that carry out a pre-programmed or programmed set of instructions.

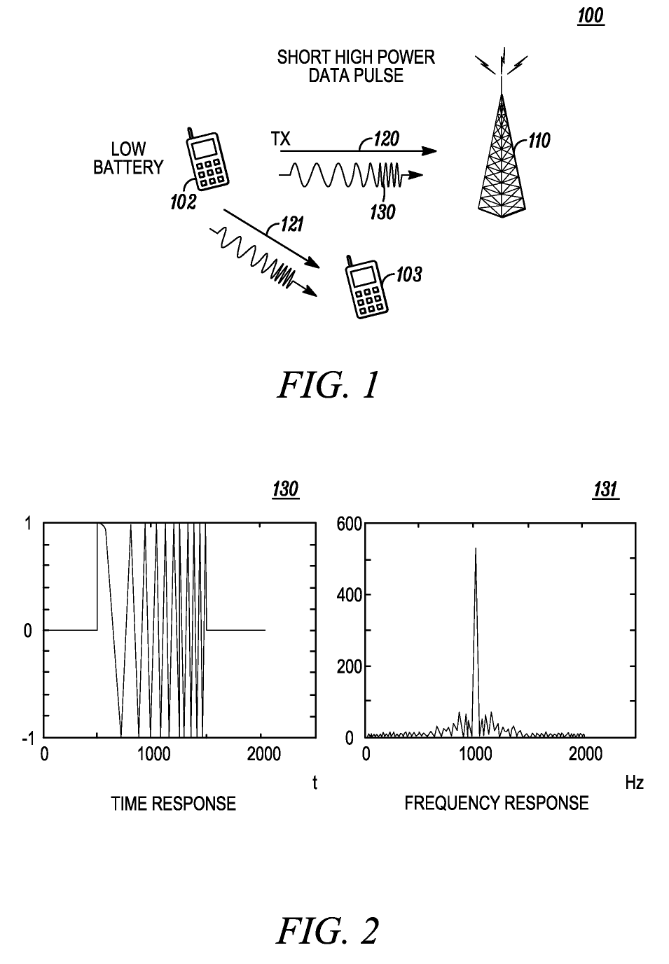

Referring to FIG. 1, a mobile communication system 100 is shown. The mobile communication system 100 can include a fixed network equipment component, such as base station 110, communicatively coupled over a radio frequency (RF) link 120 to one or more mobile communication devices 102 and 103. Notably, the mobile communication system 100 can include more infrastructure components than those shown as is known in the art. The mobile communication device 102 can be a hand-held radio, a dispatch radio, a cell phone, a portable music player, a personal digital assistant, a mounted communication system, or any other suitable communication device. The mobile communication device 102 and 103 can communicate amongst one another in an interconnect mode through the base station 110, or directly with one another in a dispatch mode, without support of the base station 110. As an example, in interconnect mode, the mobile communication device 102 can communicate with base station 110 using a standard communication protocol such as TDMA, CDMA, GSM, or any other modulation or communication protocol over the RF link 120.

In dispatch mode, the mobile communication devices 102 and 103 can communicate over one or more channels within a frequency band of the RF link 121. For example, a radio frequency spectrum can be divided into a plurality of frequency bands such as UHF and VHF. As is known in the art, Very high frequency (VHF) is the radio frequency range from 30 MHz to 300 MHz. In contrast, Ultra high frequency (UHF) designates a range (band) of electromagnetic waves whose frequency is between 300 MHz and 3.0 GHz. UHF frequencies' propagation characteristics are ideal for short-distance terrestrial communication such as radio communication. Ultra high frequency (UHF) designates a frequency range between 300 MHz and 3.0 GHz UHF frequencies' propagation characteristics are ideal for short-distance terrestrial communication such as radio communication. As one example, the UHF band can support the Family Radio Service (FRS) which is an improved two-way system or Public Safety Radio Services for providing emergency communication.

In another arrangement, the mobile communication devices 102 and 103 can communicate over a wireless local area network connection (WLAN) (not shown). In a typical WLAN implementation, the physical layer can use a variety of technologies such as 802.11b or 802.11 g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology. The mobile devices 102 and 103 can communicate with one another using low power communications, such as Bluetooth or ZigBee

Briefly, the mobile communication device 102 can operate in a normal mode during normal use or in a pulse compressed mode during emergency situations. In normal mode, the mobile device 102 is capable of transmitting communication signals within a first range, or distance. For example, in normal mode, the radio can communicate with the base station 110 if the mobile device 102 is within a cell site area of the base station. If the mobile device 102 is outside the cell site area, and there are no other base stations, or other receiving communication devices, the mobile device 102 will not be able to communicate with other devices systems in normal mode. In an emergency situation where a user of the cell phone is outside of a coverage area, the mobile device 102 can switch to pulse compressed mode which is a high gain operating mode to transmit data over a second range, greater than the first range. In pulse compressed mode a transmitter of the mobile device 102 operates at an increased power level that is above a nominal specified power level. This allows the mobile device 102 to transmit location data, or any other information, a farther distance than in normal operating mode.

The mobile device 102 can transmit a pulse compressed signal 130 at an increased power level over a long distance. The pulse compressed signal 130 is a high power signal that can be communicated over longer distances. Pulse compressing consists of spreading the signal out in time to compress the signal in frequency. As a result of the compressing in frequency, all the energy of the signal is concentrated into a high gain pulse; hence, producing a pulse compressed signal. The mobile device 102, in accordance with the embodiments of the invention, can then transmit the pulse compressed signal 130 at a high than normal gain and over a longer transmit interval while mitigating overheating due to the high power transmission. The combination of pulse compression and high gain transmission allows the signal to be transmitted further, which in the case of emergency situations allows a mobile device to provide location information outside a normal coverage area.

Referring to FIG. 2, an exemplary time domain plot 130 and frequency 135 domain plot representation of the pulse compressed signal 130 is shown. The time domain representation 130 is a chirp signal that increases in frequency over time. The chirp signal can be a frequency modulated time domain waveform as shown but is not limited to the modulation shown. The frequency domain representation 135 shows the frequency spectrum of the chirp signal. Notably, the frequency domain representation 135 concentrates a majority of the signal energy into a high gain single peak. The high gain single peak can be transmitted over a longer distance than a non-pulse compressed signal. The high gain signal has a higher signal to noise ratio in comparison to a non-pulse based system as is known in the art. In practice, the mobile device can increase a transmission power level to transmit the pulse compressed signal 130 to extend a range of communication. In particular, the mobile device evaluates a size of the data to transmit and transmits in accordance with the size based on a temperature margin profile of the transmitter stored in a look-up table. In one aspect, the transmitter can selectively transmit less often in view of the data size to prevent overheating due to the increased power level.

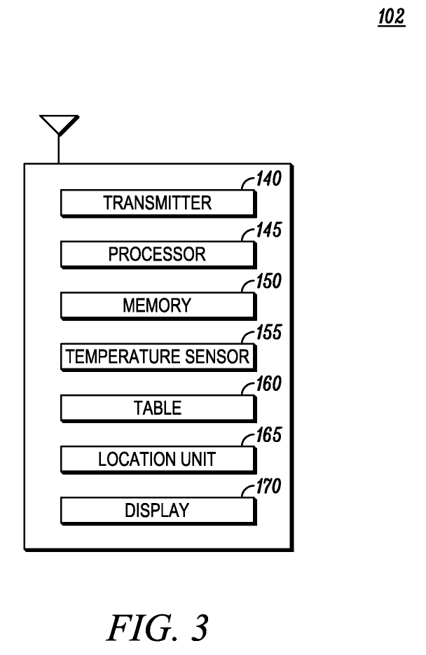

Referring to FIG. 3, a block diagram of the mobile communication device 102 is shown. The mobile communication device 102 can include a transmitter 140 that operates in a normal gain mode or a pulse compressed high gain mode, a processor 145 operably coupled to the transmitter 140 for creating a pulse compressed signal, a memory 150 containing instructions for the processor to execute, a temperature sensor 155 operably coupled to the processor 145 that measures a temperature of the transmitter 140, a look-up table 160 that identifies a temperature profile of the transmitter 140, a location unit 165 coupled to the processor 145 that identifies a location of the mobile device 102, and a display 170 that presents an operation mode and location of the mobile communication device as reported by the processor 145. The transmitter 140 also includes a power amplifier (not-shown) as known in the art for amplifying a signal prior to transmission. The temperature sensor 155 measures a temperature of the power amplifier, and the processor 145 controls a transmitting of the data based on a temperature profile stored in the table 160.

Briefly, the mobile communication device 102 can reliably send data in a high-gain pulse compressed mode without damaging the power amplifier of the transmitter 140 due to overheating. For example, if the power amplifier is operating at a higher power than it's nominal specification, excess heat will be generated that eventually reduces the efficiency of the transmitter. To prevent overheating, the processor 145 assesses the temperature of the transmitter 140 and evaluates a temperature margin based on a data size of the data, such as short messaging service (SMS) data, from the table 160. The table 160 identifies a temperature margin for the transmitter 140 as a function of data size and current transmitter temperature. The processor 145 can then control a transmitting of the data at the increased power level in view of the temperature margin.

As an example, the mobile communication device 102 can send short messaging service (SMS) data for emergency based or location type applications. The SMS data can be represented as a pulse compressed signal 130. The processor 145 can continually transmit the pulse compressed signal 130 until the transmitter 140 (e.g. power amplifier) reaches a temperature threshold. Upon the transmitter reaching the temperature threshold, the processor 145 can temporarily pause transmitting. The processor 145 can restart transmitting when a temperature margin has been reached. Notably, the processor 145 monitors a temperature from the temperature sensor 208 and controls the transmitting of data using a temperature profile stored in the table 160 to prevent overheating. In particular, the processor 145 evaluates a size of the data, and based on the size of the data and a data rate supported by the transmitter 140, determines a temperature margin for transmitting the data from the table 160. The temperature margin is included in the table 160, which the processor 145 can look up given a current transmitter temperature and data size.

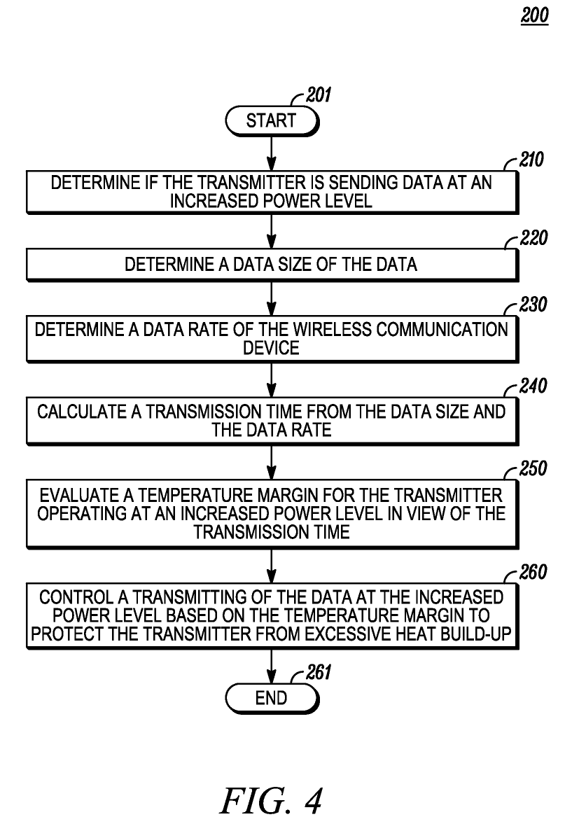

Referring to FIG. 4, a method 200 for reliably sending data from a transmitter of a wireless communication device is shown. The method 200 can be practiced with more or less than the number of steps shown. To describe the method 200, reference will be made to FIGS. 1, 2, and 3 although it is understood that the method 200 can be implemented in any other manner using other suitable components. In addition, the method 200 can contain more or less than the number of steps shown in FIG. 4.

At step 201, the method 200 can start. As an example, the method can start in a state wherein a user of a mobile device is in an emergency situation outside of a coverage area or wireless network range and desires to send an emergency beacon transmission. The method 200 can also start in a state wherein a user is within a coverage area or a local area network though poor signal strength conditions prevent the user from sending messages.

At step 210, the processor 145 can determine if the transmitter is sending data at an increased power level. For example, in normal operating mode, the transmitter operates in low power mode. In high-gain pulse compressed mode the transmitter 140 operates at an increased power level. In practice the user may select the operating mode, or the operating mode can be automatically selected, such as selecting the high-gain pulse mode in response to sending an emergency message, wherein the message contains data such as the location of the mobile device 102.

At step 220, the processor 145 can determine a data size of the data. In one arrangement, the data size can be specified as bytes. In another arrangement the data size can be specified as word lengths specific to the processor 145. At step 230, the processor 145 can determine a data rate of the wireless communication device. As an example, the data rate may be specified as 300 Kbps for CDMA, 144 Kbps for TDMA, or 10-100 Mpbs for WLAN. Notably, the data rate is specific to the transmitter 140 and supporting infrastructure. Moreover, the transmitter 140 may also support multiple data rates.

At step 240, the processor 145 can calculate the transmission time from the data size and the data rate. The transmission identifies the amount of time it takes for the transmitter 140 to send the data at the specified data rate given the data size. At step 250, the processor 145 can evaluate a temperature margin for the transmitter operating at the increased power level in view of a transmission time of the data. For example, the processor 145 can look up the temperature margin from the table 160 given the transmission time.

At step 260, the processor 145 can control a transmitting of the data at the increased power level based on the temperature margin to protect the transmitter from excessive heat build-up due to transmitting at the increased power level. In order to prevent overheating of the transmitter 140, data is only transmitted when the temperature margin is positive. Notably, the processor 145 can control the outflow of data to the transmitter 140 to prevent overheating of the power amplifier. The step 260 of controlling the transmitter 140 can include increasing or decreasing a continuous outflow of the data during the transmitting based on the data size. At step 261, the method can end.

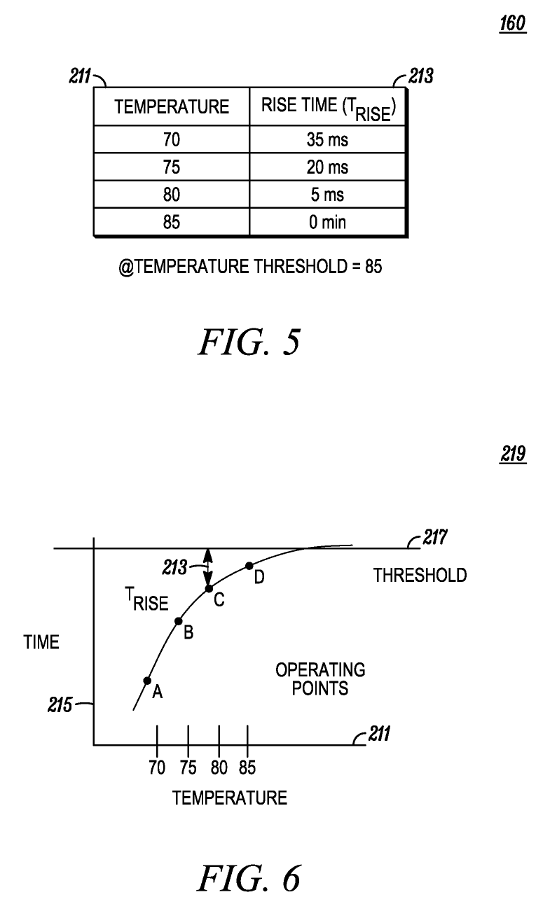

Referring to FIG. 5, the look-up table 160 is shown in greater detail. The look-up table 160 provides a temperature profile of the transmitter 140 at various operating temperatures 211. The look-up table 160 can include a present temperature entry 211 of the transmitter 212, and a rise time entry 213 for the transmitter. The rise time entry 213 identifies when the transmitter 140 will reach the maximum junction temperature (e.g. predetermined temperature threshold) at which point the efficiency of the transmitter decreases. The maximum junction temperature can be a pre-specified temperature, such as 85 degrees Celsius. The look-up table 160 can include more than the number of entries shown for describing the temperature profile.

Referring to FIG. 6, a plot diagram of an exemplary temperature profile 219 is shown for understanding the entries in table 160. Notably, the table 160 can contain a temperature profile 219 for a plurality of data rates. As shown in FIG. 6, the plot diagram represents a temperature profile 219 for only one data rate. Notably, the temperature profile 219 can be different for different data rates; that is, the curves can vary. The plot diagram plots transmitter temperature 211 versus time 215 and shows the rise time 213. The rise time 213 is specified as the amount of time, T_{Rise}, it takes the transmitter 140 to reach the predetermined temperature threshold 217. Notably, the rise time 213 is based on design or operating specifications provided with the transmitter 140.

Referring back to FIG. 5, the rise time 213 is specified as an entry column for various present temperatures 211. For example, the rise time 213 to reach the temperature threshold 217 from a present temperature of 70 degrees at operating point A is 35 ms. In contrast, the rise time to reach the temperature threshold 217 from a present temperature of 75 degrees at operating point B is 20 ms. As shown, the temperature profile may be a non-linear relationship between present temperature 211 and time 215. In such regard, the rise time 213 may decrease exponentially with an increase in transmitter temperature 211. That is, the transmitter may reach the threshold 217 faster as the temperature of the transmitter 140 increases. The temperature profile 217 inherently captures this information.

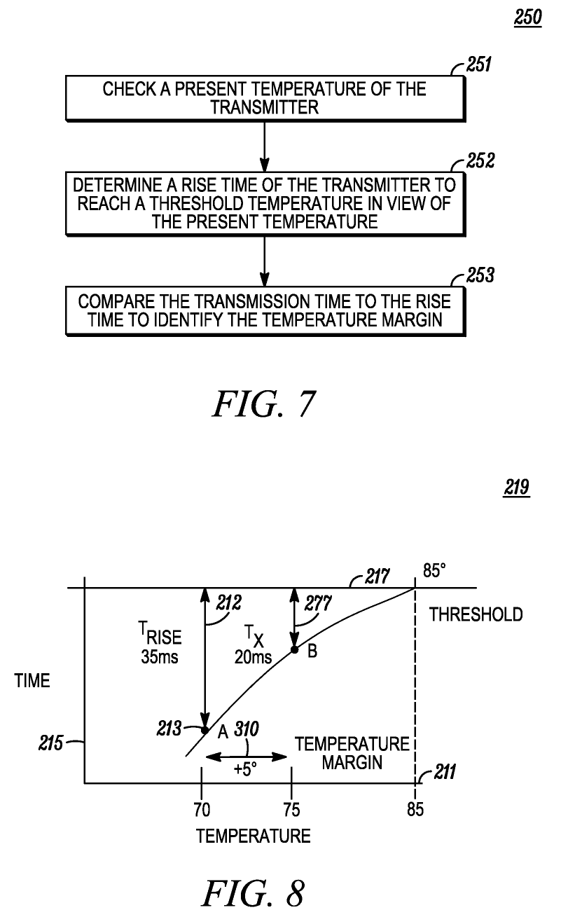

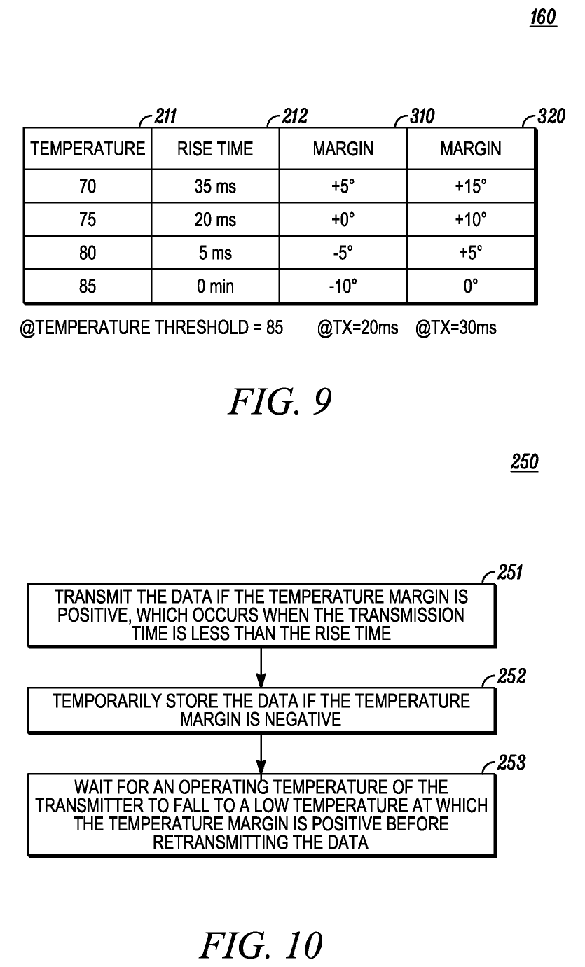

Referring to FIG. 7, the method step 250 of FIG. 5 for evaluating a temperature margin is shown in greater detail. When describing the method 250, reference will be made to FIGS. 8 and 9 for visually illustrating the temperature margin. The method step 250 can include more or less than the number of components shown and is not limited to the order shown.

At step 251, the processor 145 can check a present temperature of the transmitter when ready to transmit the data. For example, referring back to FIG. 3, the processor 145 can receive temperature readings from the temperature sensor 208 during high-gain pulse compressed transmit mode. At step 252, the processor 145 can determine a rise time 213 of the transmitter to reach a threshold temperature 217 in view of the present temperature. In one arrangement, the processor 145 can look-up the rise time from the table 160 as shown in FIG. 5. In another arrangement, the processor 145 can calculate the rise time from the temperature profile 219 as shown in FIG. 6. At step 254, the processor 145 can compare the transmission time to the rise time to identify the temperature margin.

The temperature margin identifies when the transmitter 140 will reach a temperature threshold, at which point a transmission efficiency is reduced. Referring to FIG. 8, a more detailed illustration of the temperature profile 219 of FIG. 6 for describing the temperature margin 310, rise time 213, and transmission time 277 is shown. The temperature margin 310 is the margin between two operating temperatures. For example, the temperature margin 310 can be defined as the temperature difference between the present transmitter temperature associated with a rise time 213 and a temperature associated with a minimum transmission time 277 for data of a specified size. Recall, the transmission time 277 is a function of the data size and the data rate. And, the transmitter temperature is a function of the data throughput. Accordingly, the temperature margin 310 decreases due to heat dissipation as the transmitter 140 continues to transmit data at the data rate over prolonged periods of time. When the temperature margin 310 is positive, the transmitter is operating efficiently. When the temperature margin 310 is negative, the transmitter has overheated and is operating inefficiently.

FIG. 8 illustrates an exemplary temperature profile 219 for a transmitter transmitting data of a certain size at different transmitter temperatures. The temperature margin 310 is dependent on the present transmitter temperature 211 and the transmission time 277, which is a function of the data size. For example, based on the times shown in FIG. 8 for a given data size, a message of size 10 bytes, will take a transmission time of 20 ms (277) for a transmitter providing a data rate of 200 bytes/s. If the transmitter is operating at present temperature of 70°, as shown in FIG. 9, the corresponding rise time (212) is 35 ms. Consequently, the transmitter can transmit all 10 bytes without overheating the transmitter 140, since the transmission time (20 ms) 320 is less than the rise time 310 (35 ms). If however, the transmitter is operating at a present temperature of 80°, the transmitter will begin to overheat, since the transmission time (20 ms) 277 is greater than the rise time 213 (5 ms) at 80° (See FIG. 9). In such regard, the temperature margin 310 identifies the relationship between present transmitter temperature 211 and a transmission time 277 associated with a certain data rate

Referring to FIG. 9, the look-up table 160 is shown in greater detail. In particular, a temperature margin is provided for each data rate. For example, a temperature margin 310 for a first transmission time of 20 ms is shown, and a second temperature margin 320 for a transmission time of 30 ms is shown. Notably, the table 160 can include more entries for different data size and transmission rates. In such regard, the processor 145 can look-up the temperature margin directly from the table given the data size and current operating temperature. The processor 145 can then control the transmissions in accordance with the temperature margin. Also, it should be noted that the temperature margin 310 (320) is a function of the transmission time 277 since the transmitter will operate in continuous mode. Moreover, the change in temperature of the transmitter is non-linear with respect to time. In practice, the temperature margin generally decreases exponentially as a function of the data size.

Referring to FIG. 10, the method step 260 of FIG. 5 for controlling a transmitting of the data based on the temperature margin is shown in greater detail. The method step 260 can include more or less than the number of components shown and is not limited to the order shown. Moreover, it should be noted that the temperature margin is dependent on the data size, which establishes a transmission time based on a data rate of the transmitter. Accordingly, the transmission time is a function of the data rate. At step 251, the processor 145 can transmit the data if the temperature margin 310 is positive, which occurs when the transmission time 277 is less than the rise time 213. Alternatively, at step 252, the processor 145 can temporarily store the data if the temperature margin 310 is negative. At step 253, the processor can wait for an operating temperature of the transmitter 140 to fall to a low temperature at which the temperature margin 310 is positive before retransmitting the data.

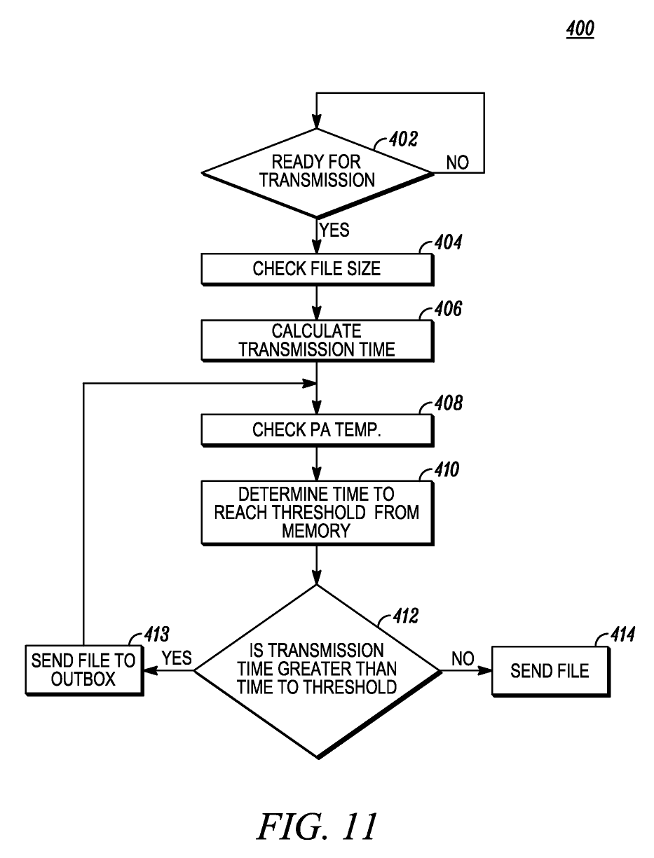

Referring to FIG. 11, an exemplary flowchart 400 for practicing the method 200 is shown. The flowchart may include more or less steps than shown in actual practice of the method 200. At step 402, the processor 145 can determine if the transmitter 140 is ready to transmit a message. The message can comprise Short Messaging Service (SMS) data for sending location data in an emergency situation. For example, the processor 145 may receive location data from the location unit 165 to send with the SMS message. If the transmitter 140 is not ready, the processor can enter a wait state to check for transmission at a later time. If the transmitter is ready, at step 404, the processor 145 can check a file size of the message. For example, the processor can count the number of bytes required to transmit the message. At step 406, the processor 145 can calculate the transmission time in view of the data size. The processor can determine the data rate of the transmitter and calculate the transmission time from the data rate and the data size. At step 408, the processor 145 can check a temperature of the power amplifier of the transmitter. The processor 145 can poll the temperature sensor 208 for the transmitter temperature. Notably, the processor 145 can continually monitor the transmitter temperature during transmission.

At step 410, the processor 145 can determine the time it takes to reach a predetermined threshold. For example, the predetermined temperature threshold may be a maximum junction temperature, such as 85°. Referring back to FIG. 9, the processor 145 can look-up the rise time 213 from the temperature margin. For instance, if the transmitter is at a present temperature of 70°, the rise time to send a message having a transmission time of 20 ms is 35 ms. At step 412, the processor 145 can determine if the transmission time is greater than the time to reach the predetermined threshold. For example, referring back to FIG. 8, the processor 145 will determine if the rise time 213 is greater than the transmission time 277. If so, referring back to FIG. 11, at step 414, the processor 145 will request the transmitter to send the message. If the transmission time is less than the time to reach the predetermined threshold, the transmitter will overheat. Accordingly, the processor can either temporarily suspend transmission without shutting down the transmitter, or can limit the amount of data to send to prevent the transmitter from overheating.

In one arrangement, at step 413, the processor 145 can send the file to an outbox. The data in the outbox can be sent to the transmitter in accordance with the data flow established by the processor 145. The processor 145 can continue to monitor the outflow of data from the outbox to the transmitter 140 during transmission. In such regard, the processor prevents the power amplifier of the transmitter 140 from overheating without shutting down the transmitter 140.

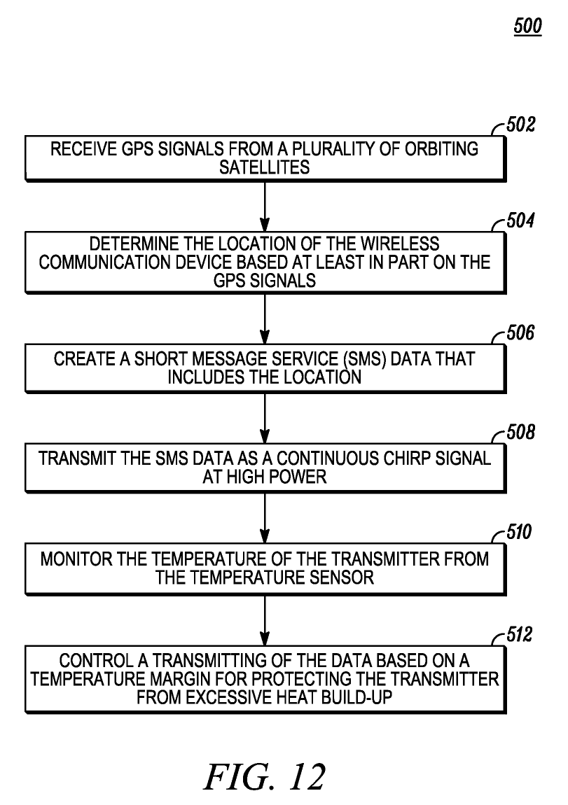

Referring to FIG. 12, a method for reliable sending a location message in an emergency situation is shown. The method may contain more or less than the number of steps shown. When describing the method, reference will be made to FIG. 2 for identifying enabling components. At step 502, the location unit 165 receives GPS signals from a plurality of orbiting satellites. The GPS signals identify a location of the mobile device 102. At step 504, the processor 145 determines a location of the mobile device based at least in part on the GPS signals. At step 506, the processor creates a short message service (SMS) data that includes the location. At step 508, the transmitter 140 transmits the SMS data as a continuous chirp signal at high power. At step 510, the processor monitors the temperature of the transmitter from the temperature sensor 155. At step 512, the processor controls a transmitting of the data based on a temperature margin for protecting the transmitter from excessive heat build-up. The processor can determine the temperature margin in accordance with the method 200. The method 500 allows a mobile device to operate a transmitter at a higher than normal power level. In such regard, the mobile device can send SMS data which includes location information during emergency situations without damaging the transmitter due to overheating.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for reliably sending data from a transmitter of a wireless communication device, the method comprising:
determining if the transmitter is sending data at an increased power level;
evaluating a temperature margin for the transmitter operating at the increased power level in view of a transmission time of the data; and
controlling a transmitting of the data at the increased power level based on the temperature margin to protect the transmitter from excessive heat build-up due to transmitting at the increased power level.

2. The method of claim 1, wherein the step of evaluating a temperature margin further comprises:
determining a data size of the data;
determining a data rate of the wireless communication device; and
calculating the transmission time from the data size and the data rate,
wherein the step of controlling includes increasing or decreasing a continuous outflow of the data during the transmitting based on the data size.

3. The method of claim 1, wherein the step of evaluating a temperature margin further comprises:
checking a present temperature of the transmitter;
determining a rise time of the transmitter to reach a threshold temperature in view of the present temperature; and
comparing the transmission time to the rise time to identify a temperature margin.

4. The method of claim 3, further comprising transmitting the data if the temperature margin is positive which occurs when the transmission time is less than the rise time.

5. The method of claim 3, further comprising:
temporarily storing the data if the temperature margin is negative; and
waiting for an operating temperature of the transmitter to fall to a low temperature at which the temperature margin is positive and results in a rise time that is greater than the transmission time before retransmitting the data.

6. The method of claim 3, wherein the step of determining a rise time further comprises:
performing a look-up search in a table that charts a temperature of the transmitter versus time with respect to the data rate,
wherein the rise time is a time it takes for the transmitter operating at the increased power level to reach the threshold temperature at the data rate.

7. The method of claim 6, wherein the table includes a temperature profile of the transmitter at the increased power level for a plurality of data rates and transmission times.

8. The method of claim 1, wherein the step of transmitting consists of sending a pulse compressed signal at a transmitter peak power to increase a transmit range of the wireless communication device in an emergency.

9. The method of claim 1, further comprising sending location specific information in the pulse compressed signal for identifying a location of the wireless communication device.

10. A wireless communication device comprising: a processor; a transmitter operably coupled to the processor that transmits data; and a memory operably coupled to the processor, the memory storing operating instructions that, when executed by the processor, cause the processor to:
determine if the transmitter is sending data at an increased power level;
determine a data size of the data;
determine a data rate of the wireless communication device;
calculate a transmission time from the data size and the data rate;
evaluate a temperature margin for the transmitter operating at an increased power level in view of the transmission time, and
control a transmitting of the data at the increased power level based on the data size in view of the temperature margin for protecting the transmitter from excessive heat build-up due to transmitting at the increased power level.

11. The wireless communication device of claim 10, further comprising a temperature sensor operably coupled to the processor that measures a temperature of the transmitter to control a transmitting of data depending on the data size, wherein the operating instructions further cause the processor to:
receive temperature readings from the temperature sensor;
check a present temperature of the transmitter when ready to transmit the data;
determine a rise time of the transmitter to reach a threshold temperature in view of the present temperature; and
compare the transmission time to the rise time to produce the temperature margin.

12. The wireless communication device of claim 10, wherein the operating instructions further cause the processor to:
transmit the data if the transmission time is less than the rise time at which the temperature margin is positive; and,
temporarily store the data if the temperature margin is negative, and wait for an operating temperature of the transmitter to fall to a low temperature at which the temperature margin is positive and results in a rise time that is greater than the transmission time before retransmitting the data.

13. The wireless communication device of claim 10, further comprising a look-up table that charts a temperature of the transmitter versus time, wherein the operating instructions cause the processor to perform a look-up search for a rise-time in the table, wherein the rise time is a time it takes for the transmitter operating at the increased power level to reach the threshold temperature at the data rate.

14. The wireless communication device of claim 10, wherein the table includes a temperature profile of the transmitter at the increased power level for a plurality of data rates and a plurality of transmission times.

15. The wireless communication device of claim 10, further comprising a global positioning system (GPS) receiver, operably coupled to the processor, for receiving GPS signals from a plurality of orbiting satellites; and wherein the operating instructions further cause the processor to determine the location of the wireless communication device based at least in part on the GPS signals, and transmit the location with the data.

16. The wireless communication device of claim 10, further comprising a display operably coupled to processor that identifies when the transmitter is operating at the increased power level in an emergency situation.

17. A wireless communication device tracking system comprising a processor; a transmitter operably coupled to the processor; a temperature sensor operably coupled to the processor that measures a temperature of the transmitter; a location unit coupled to the processor; and memory operably coupled to the processor and location unit, the memory storing operating instructions that, when executed by the processor, cause the processor to: determine a location of a wireless communication device from the location unit; create a short message service (SMS) data that includes the location; determine a file size of the SMS data; determine a data rate of the wireless communication device; calculate a transmission time from the file size and the data rate; evaluate a temperature margin for the transmitter operating at an increased power level in view of the transmission time; and control a transmitting of the data by the transmitter at the increased power level based on the temperature margin for protecting the transmitter from excessive heat build-up due to transmitting at the increased power level.

18. The wireless communication device tracking system of claim 17, wherein the transmitter is a pulse compression system that transmits the SMS data as a continuous chirp signal at high power for transmitting the SMS data over a long range, wherein the processor monitors the temperature of the transmitter from the temperature sensor in view of the file size, and decreases transmissions when the temperature margin is negative and increases transmissions when the temperature margin is positive.

19. The wireless communication device tracking system of claim 17, further comprising a look-up table that charts a temperature of the transmitter versus rise time, wherein the operating instructions cause the processor to perform a look-up search for a rise-time in the table that corresponds to a file size and data rate, wherein the rise time is a time it takes for the transmitter operating at the increased power level to reach a threshold temperature at the data rate, and the processor subtracts the transmission time from the rise time to produce the temperature margin.

20. The wireless communication device tracking system of claim 17, wherein the operating instructions further cause the processor to:
transmit the SMS data if the temperature margin is positive, at which the transmission time is less than the rise time; and,
temporarily store the SMS data if the temperature margin is negative, and wait for an operating temperature of the transmitter to fall to a low temperature at which the temperature margin is positive and results in a rise time that is greater than the transmission time before retransmitting the SMS data.
